(19) United States
(12) Patent Application Publication
(10) Pub. No.: US 2011/0088971 A1
(43) Pub. Date: Apr. 21, 2011

(54) Collapsible step and extension ladder

(76) Inventor: Herbert Jaffe, (US)

(21) Appl. No.: 10/668,424

(22) Filed: Sep. 22, 2003

Related U.S. Application Data
(60) Provisional application No. 60/412,712, filed on Sep. 23, 2002.

(51) Int. Cl. E06C 1/38; E06C 1/397; E06C 7/46; E06C 7/50

(52) U.S. Cl. 182/21; 182/178.2; 182/178.3; 182/107

(57) ABSTRACT

A ladder formed of easily storable sections is quickly assembled to form a step ladder, extension ladder, hoist, scaffolding or fence. The base and top of the extension ladder include separate stabilizers which prevent the ladder from tipping or from damaging the fascia. The upper stabilizer may be converted to perform a second function as a hoist, substantially reducing the cost and space needed for storage of the invention.

### BACKGROUND

1. Field

The present invention relates to collapsible ladders and more particular to such ladders which may be disassembled into separate sections.

2. Prior Art

There are prior art ladders that are collapsible as can be seen from the following three patents.

U.S. Pat. No. 3,993,714 is a ladder that can be assembled from sections; however, it is designed for use in climbing poles and must be lashed to the pole for support.

U.S. Pat. No. 4,493,392 is a collapsible ladder that folds in on itself, but does not separate into sections. The whole weight of the ladder must be carried at all times when it is moved, even when it has been collapsed in preparation to be moved into storage.

U.S. Pat. No. 5,645,140 shows a collapsible ladder in which the supports running from rung to rung are designed to telescope into the support below. This is a complicated, costly design to manufacture. The ladder is never disassembled into sections and the full weight of the ladder must be transported as a unit at all times. This ladder also has a bottom stabilizer which only extends in a direction in which the ladder is normally supported and fails to support the ladder in the direction in which it can easily tip in normal use.

The present invention is designed to overcome the shortcomings of these prior art inventions.

### BRIEF DESCRIPTION OF THE FIGURES

FIG. 1 is a perspective drawing showing the ladder disassembled into sections and stored on a rack that is constructed of components of the ladder.

FIG. 2A is a detailed drawing showing a first means of connecting the ladder sections.

FIG. 2B is a detailed drawing showing a second means of connecting the ladder sections.

FIG. 2C is a detailed drawing showing a third means of connecting the ladder sections.

FIG. 2D is a detailed drawing showing a rectangular cross sectional connection.

FIG. 2E is a detailed drawing showing a fourth means of connecting the ladder sections.

FIG. 2F is a detailed drawing showing a fifth means of connecting the ladder sections.

FIG. 2G is an elevation view of a fence formed of ladder sections using the means for connecting shown in FIG. 2F.

FIG. 2H is a detailed drawing showing a sixth means for connecting the ladder sections.

FIG. 2I is a vertical elevation of scaffolding formed of ladder sections and the means for connecting shown in FIG. 2H.

FIG. 3A shows the sections used to form an extension ladder.

FIG. 3B shows the sections used to form a step ladder.

FIG. 4A shows a top stabilizer that is moveable along the ladder and can be used to prevent damage to the fascia of a home.

FIG. 4B is a side view of a stabilizer block.

FIG. 5A is a plan view of a first hoist for use with the present invention.

FIG. 5B is a side elevation view of the hoist shown in FIG. 5A.

FIG. 5C is a plan view of a second hoist for use with the present invention.

FIG. 5D is a side elevation view of the second hoist shown in FIG. 5C.

FIG. 6 is a side elevation view of a ladder of the present invention used with the hoist of FIG. 5A.

### SUMMARY

It is an object of the present invention to provide a ladder that can be disassembled into easily handled sections.

It is an object of the present invention to provide a ladder formed of sections which can be assembled into a step ladder, an extension ladder, a hoist, scaffolding or a fence and a cart used for transport made from the ladders own components.

An object of the present invention is to provide an extension ladder which includes both an upper and a lower stabilizer to prevent tipping and damage to the fascia siding or roof of a home.

An object of the present invention is to provide an extension ladder with means of easily hauling material to the top of the ladder.

The present invention is a ladder formed of easily storable sections that may be quickly assembled to form a step ladder or an extension ladder, a hoist, scaffolding or a fence. The base and top of the extension ladder include separate stabilization sections which prevent the ladder from tipping or from damaging the fascia. The upper stabilizer can be easily converted into a hoist for hauling material to the top of the ladder.

The separate sections of the ladder permit it to be stored in a small space or on a cart which allows storing the ladder in an area that is much smaller than that required for a comparable sized extension ladder. The ladder also includes both an upper and a lower stabilizer which prevents tipping and also holds the ladder away from fascia boards to prevent damage to the fascia often caused by conventional extension ladders.

### DETAILED DESCRIPTION OF THE INVENTION

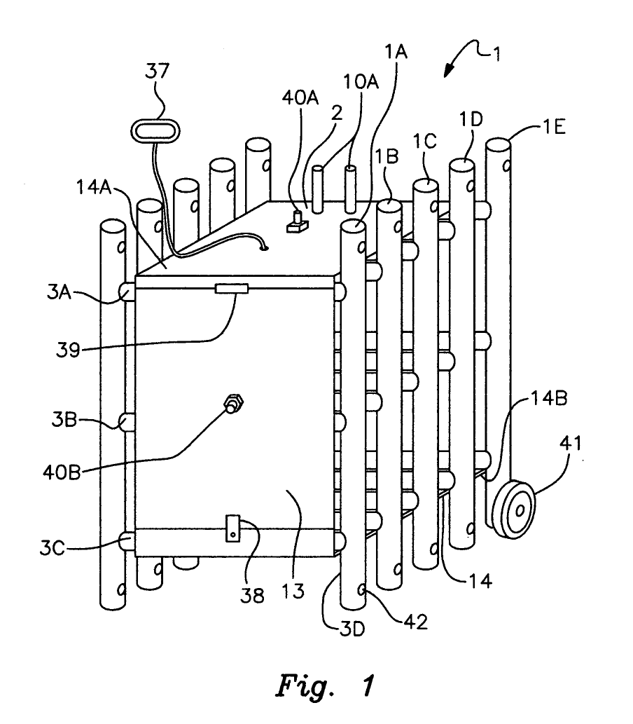

FIG. 1 shows a perspective drawing 1 of the ladder disassembled into sections and stored on a carry cart or rack 2. The rack 2 can be seen to be holding five sections of the ladder 1A through 1E. The first ladder section 1A can be seen to have three cross runs running horizontally in the drawing and designed by drawing numbers 3A through 3C. The compact arrangement of storing the ladder sections is shown in FIG. 1 permits the present invention to be stored in a relatively small space as compared to a fully extended extension ladder. The ladder sections are shown spaced apart for clarity, but in normal use the sections are bundled tightly together to provide a small package.

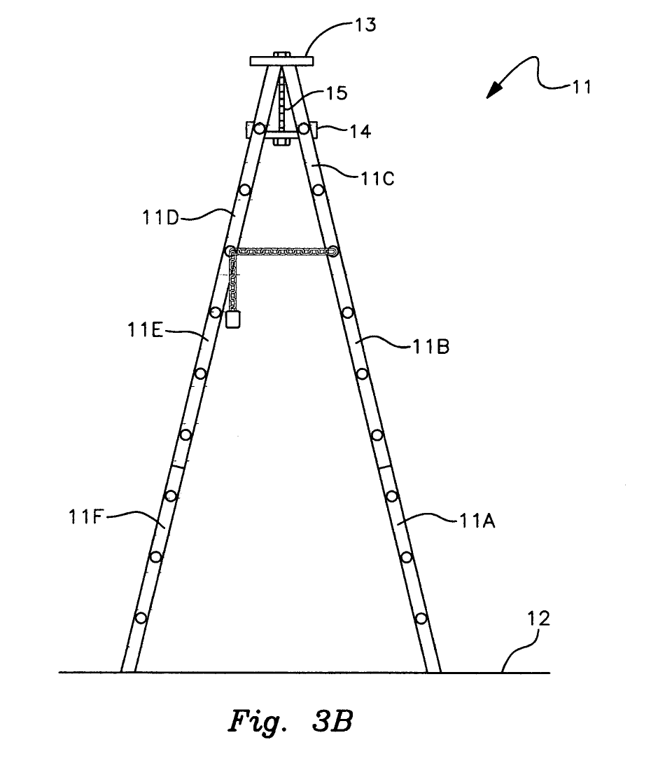

Each ladder section contains a hole, such as hole 42, at the top and the bottom of the rails, or vertical support arms of the ladder sections, such as in rail 3D. This hole is used to permit a stabilizer rod to pass through the vertical support arms. A stabilizer rod used in this way is shown in FIG. 3A.

These holes are also used to hold an axil on which two wheels such as wheel 41, may be mounted to assist in moving the rack about. A flexible handle 37 mounted on the top of the rack is also used to assist in moving the rack.

The rack is held together by means of rectangular panels 13 and 14A and 14B with the aid of tie rods and bolts 40A and 40B, respectively and stop plate 39 and latch 38. Panel 13 is the front panel, 14A is the top panel and panel 14B is the bottom panel. The panel 13 is used in the assembly of the ladder as shown in FIG. 3B where panel 13 forms the top plate of the ladder.

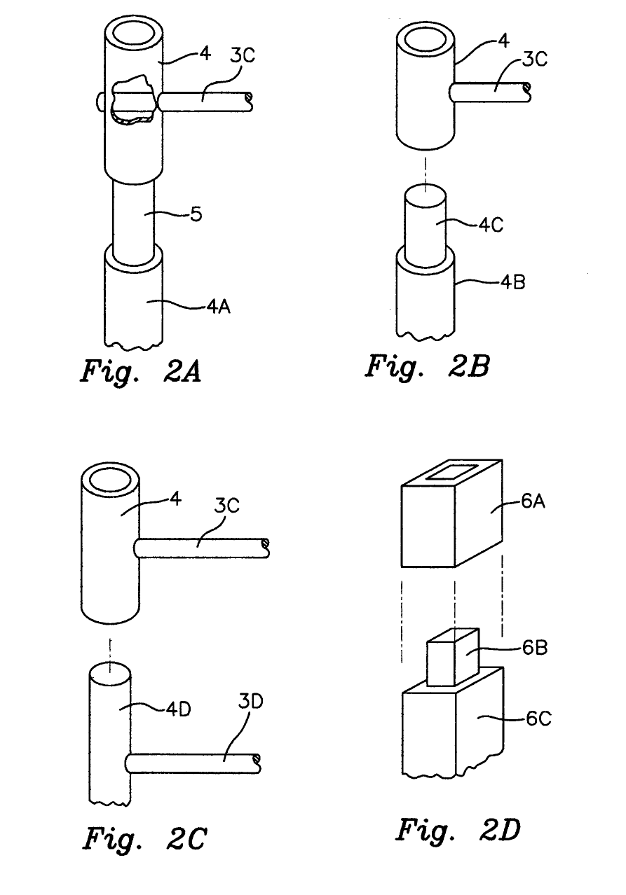

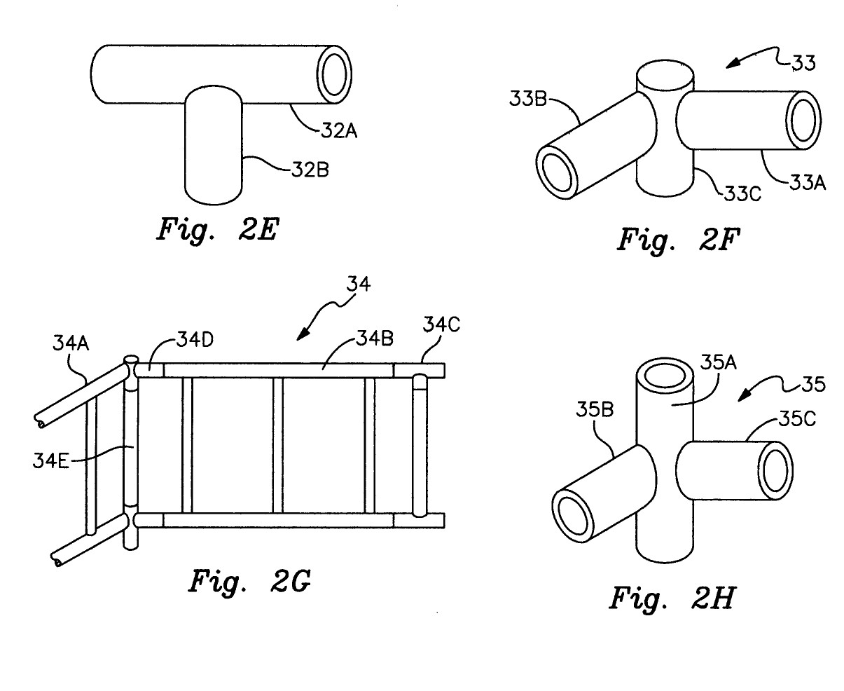

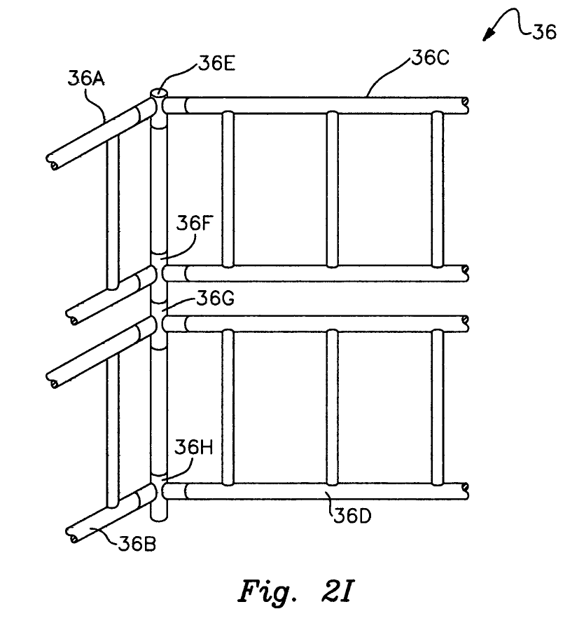

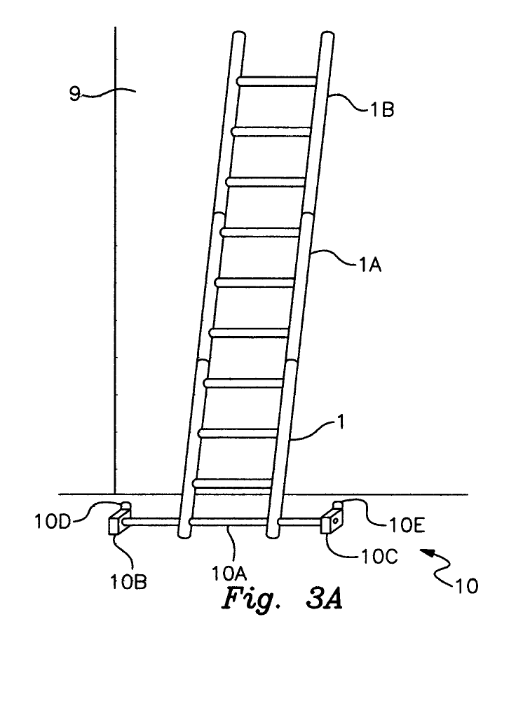

FIGS. 2A through 2C show three different ways in which the sections can be connected together. The sections of the ladder are connected together at the upper and lower ends of their vertical support arms. It is the ends of the vertical support arms that is shown in these Figures and in particular, the ends of vertical support arms at one side of the ladder. FIG. 2A comprises a first vertical support arm 4 of a first section of the ladder, a second vertical support arm 4A of a second section, a third rung 3C extending from the side of vertical support arm 4, and an insertable locking link 5. In this Figure, the first vertical support arm 4 is shown cut away in front of the third rung 3C. The rung 3C can be seen to pass through the vertical support arm 4. The locking link 5 is a cylindrical segment that may be formed of many materials including a short section of pipe having the proper diameter to fit closely within the hollow support arm. In the assembly process, the locking link is inserted in the vertical support arm 4. The rung 3C is used as a stop for the locking link in the support arm 4. Other suitable means of forming a stop may be used, such as a narrowing or a protrusion within the vertical support arm. The support arm 4A represents the upper end of the support arm from the next adjacent lower section of the ladder. Once the locking link 5 has been placed into the hollow center of the vertical support arm 4A, it holds the upper vertical support arm 4 in position directly above the lower vertical support arm 4A. Although not shown, the first rung of ladder section 4A also has a rung that is similar to 3C. This rung acts as a stop for the locking link 5 in ladder section 4A.

FIG. 2B is a detailed drawing showing a second means of connecting the ladder sections. The vertical support arm 4 and rung 3C are identical to that shown in FIG. 2A. The difference between this Figure and FIG. 2A is contained in the lower vertical support arm 4B, which now includes a narrow extension 4C. The extension 4C is designed to fit closely within the hollow center of the support arm 4 above it, and lock the support arm 4A to support arm 4. This arrangement eliminates the need for stops provided by the rungs. The wider portion of 4A below the extension acts as a stop and the extension itself eliminates the need for a separate locking link 5 as was used in FIG. 2A. For this configuration the locking link is essentially built on to the end of the ladder support arm.

FIG. 2C is a detailed drawing showing a third means of connecting the ladder sections. The upper vertical support arm 4 and the rung 3C are identical to that shown in FIGS. 2A and 2B. The difference between this Figure and FIG. 2 a is contained in the lower support arm 4D which is now sufficiently narrow itself to fit within the hollow center portion of the support arm 4. The vertical support arm 4D remains the same diameter throughout its length. If a ladder section is to be connected to the lower end of 4D, it must be a wide diameter vertical support arm similar to that of support arm 4, shown above 4D in FIG. 2C. Alternate wide and narrow sections are used with this type of ladder section to build an extension ladder.

It is clear that the connecting links can be either internal or external. No links are needed if one member to be connected to a second member is at its end sized to fit over the second member or sized to fit inside the second member.

The support arms of the ladder sections need not be circular in cross section, but can be any one of many different configurations. A common cross section is rectangular as shown in FIG. 2D, where the upper support arm 6A is rectangular and includes a rectangular hollow center. The support arm 6C below that includes a narrow rectangular extension 6B which is used as a locking link and which closely fits within the hollow center of the support arm 6A, locking the support arm 6A to that of 6B. There is usually no need to secure the locking link 6B within the support arms as the weight of a person on the ladder tends to hold the locking links in their position within the support arms; however, a locking mechanism such as a thumb screw extending in from the side of the support arm and through the side wall of 6A, can be used to apply pressure to the locking link 6B to secure it in position, even when there is a no one on the ladder.

FIG. 2E is a detailed drawing showing a fourth means of connecting the ladder section 32 consisting of a horizontally positioned hollow cylinder 32A and a vertically positioned hollow cylinder 32B that is connected at one end to the mid section of 32A and is positioned orthogonally to 32A.

FIG. 2F is a detailed drawing showing a fifth means 33 of connecting the ladder sections consisting of a first horizontally positioned hollow cylinder 33A, a second horizontally positioned cylinder 32B and a vertically positioned hollow cylinder 32C. The first and second cylinders in this coupling means are orthogonally positioned with respect to one another and both of these cylinders are orthogonally positioned with respect to the third cylinder. The first two cylinders are at the same vertical level and are joined to sides of the third cylinder. The top of the third cylinder is capped.

The means of connecting 32 and 33 are used with ladder sections to form a fence as shown in FIG. 2G. In the fence, the ladder sections are rotated 90° with respect to their normal position in a ladder. For the straight position of the fence, the ladder sections are connected together by means of the connecting means 32 along with the locking link 5 shown in FIG. 2A. The locking link is slid into both the end of the vertical support arm of the ladder section and into the cylinder 32A. Two connecting means 32 are used for the connectors, one at the top and one at the bottom of the fence. A pipe section, typically of PVC, runs between the two means of connecting 34. A useful variation is to substitute a modified version of the connecting means 32 which has another cylinder identical to cylinder 32B attached diametrically opposite 32B on the opposite side of 32A to provide a means of connecting for a section of pipe that can be used to support the fence in the ground.

A 90° angle in the fence can be accommodated by connecting the ladder sections to a connecting means which provide a right angle feature such as connecting means 33 which has cylinder 33A and 33B at right angles to one another and which are designed to be connected to the ladder section using locking links. A corner post 34 made from a pipe section is connected to cylinder 33C shown in FIG. 2F.

FIG. 2H is a detailed drawing showing a sixth means for connecting the ladder sections to form scaffolding as shown in FIG. 2I. The means for connection 35 shown in FIG. 2H includes a hollow vertical cylinder 35A, a first horizontally positioned hollow cylinder 35C and a second horizontally positioned hollow cylinder 35B. All three cylinders are mutually perpendicular to one another. The cylinders 35B and 35C are connected to the sides of cylinder 35A.

As can be seen in FIG. 2I, the four fence sections 36A through 36D are positioned horizontally and are connected to four means for connecting 35 designated by drawing numerals 36E through 36H. The locking link 5 is used to make the connections and the fence sections can be secured by pins placed in holes drilled through the fence sections and locking links and holes drilled in the connecting means and the locking links.

FIG. 3A shows the ladder sections connected together to form an extension ladder. This ladder comprises four ladder sections 1, 1A, 1B, and 1C, all of which are held together using the lock link 5 shown in FIG. 2A. This ladder is being used to scale a wall 9 and is held in place at its base with a bottom stabilizer 10.

The bottom stabilizer 10 comprises a stabilizer rod 10A, a left block 10B, a right block 10C, a first spike 10D and a second spike 10E. A spike is included as a part of each of the stabilizer block. The spike is used to dig into the soil to prevent movement of the ladder. The ladder as shown in is FIG. 3 is prevented from tipping to the right or left by means of the bottom stabilizer, which extends out farther than the support arms of the ladder. The spikes are dug into the soil to provide a counter torque to any tipping and holding force against any sliding action of the ladder.

FIG. 3B shows the ladder sections used to form a step ladder 11, where the ladder sections are held together by means of a locking link 5. The ladder is shown resting on ground surface 12. This ladder is comprised of six sections, 11A through 11F, a top plate 13, a locking block 14 and a bolt 15. The ladder is assembled by connecting together three ladder section, such as 11A through 11C, by means of locking links 5 and separately connecting the remaining three section of the ladder 11D through 11F by means of additional locking links 5 to form two halves of the ladder which are shown to the left and to the right in FIG. 3B. The left and right hand portions of the step ladder are placed together at their tops and the plate 13 is placed over this point of contact between the left and right hand portions of the ladder. The locking block 14 is placed below the first rung down from the top of the ladder and has a first channel on the left and a second channel on the right side to accept the first rung down on the left and right hand side of the ladder respectively. This block is pulled up tight against these first rungs by means of a bolt 15. The bolt 15 is extended between the top plate 13 and a locking block 14. When it is tightened, it prevents the spreading apart of the right and left portions any further than the channels in the locking block 14 will allow the rungs to move.

One useful advantage of the ladder of FIG. 3B is it may be climbed from either side or two people can climb opposite sides simultaneously. This is very useful when two people are needed to do a job at the top of a ladder.

The step ladder of FIG. 3B is prevented from spreading apart by the locking block 14 and is also prevented from spreading by a chain 11K which has plugs 11K1 and 11K2 attached to its ends as shown in this Figure. The plugs are inserted into the rung openings. Different chain lengths are provided to accommodate different height ladder assemblies. Two chains maybe used, with one on each side of the ladder.

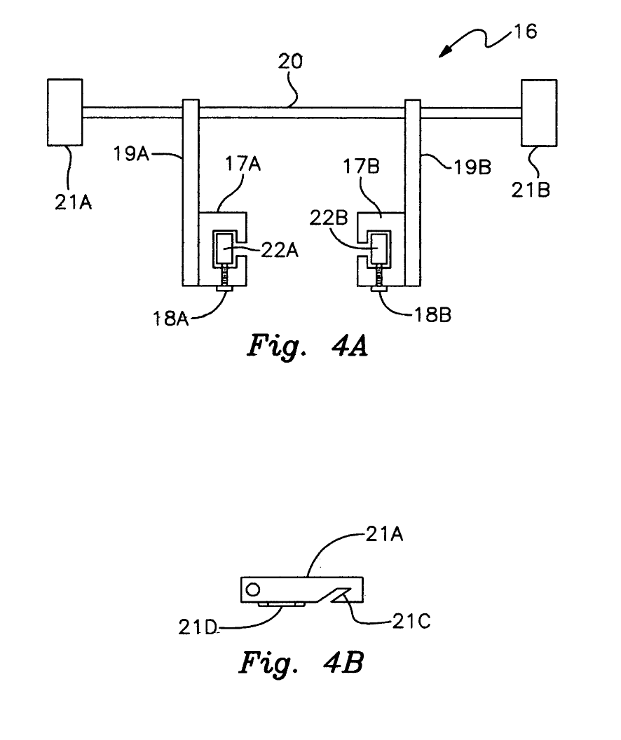

FIG. 4A shows a top stabilizer that is moveable along the ladder and can be used to prevent damage to the fascia of a home. The complete top stabilizer assembly is designated by drawing numeral 16 comprises a left stabilizer rail collar 17A, a right stabilizer rail collar 17B, a left set screw 18A, a right set screw 18B, a left extension arm 19A, a right extension arm 19B, an upper stabilizer rod 20, a left block 21A and a right block 21B. The stacking of the ladder section causes the support arms to form the ladder rails. The collars are slipped over the left and right rails of the ladder 22A and 22B and set at a level desired by means of set screws 18A and 18B which are screwed through the blocks and into the rails to clamp the stabilizer in place against the rails. Attached to the sides of the collars are left and right extension arms 19A and 19B which extend from the ladder towards the house and over the roof. Passing through the ends of the extension arms 19A and 19B is the upper stabilizer rod 20, which extends out to the left and to the right beyond the position of the stabilizer arm. At the ends of the rod 20 are the left and right blocks for the upper stabilizer.

In the operation of the top stabilizer 16, the collars are placed over the rails of the ladder and slid into position and clamped in place by means of the set screws 18A and 18B, which are tightened against the rails 22A and 22B to set the stabilizer in place on the ladder at a desired level. The extension arms 19A and 19B support the rod 20 and the blocks 21A and 21B located at the end of rod 20. The ladder is placed at a distance away from the house and the blocks of the upper stabilizer are set in place on the roof allowing the ladder to rest on the roof of the house without crushing the fascia. The blocks 21A and 21B typically have rubber padding on one side to enable them to rest on the roof of the house without damaging it.

FIG. 4B shows a side view of the stabilizer clock 21A which has a cut out 21C for a cable used as necessary to hold the block from slipping and a rubber pad 21D used for the same purpose as well as preventing damage to the building.

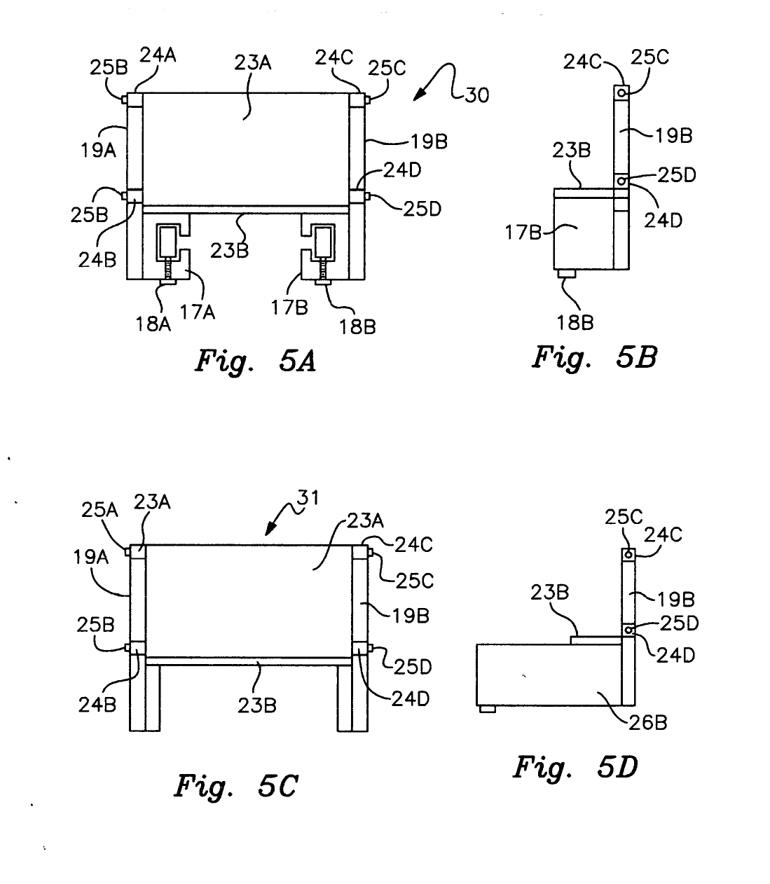

The ladder of the present invention may be used to hoist materials to high levels such as the roof of a home. Materials of this type may include paint and heavy items such as shingles. A first hoist 30 of this type is shown in plan view in FIG. 5A. It comprises a platform 23A, a platform back stop 23B, platform mounting brackets 24A through 24D and locking screws for the mounting brackets 25A through 25D. The first hoist also includes components from the top stabilizer 16, such as the left and right rail collar 17A and 17B, the left and right set screws 18A and 18B and the left extension arms 19A and 19B.

The top stabilizer can be converted to form a hoist by removing the stabilizer bar 20 and the left and right block 21A and 21B. The platform 23A with a back stop attached is clamped to the extension arms by means of the four brackets 24A through 24D and the locking screws 25A through 25D. This conversion saves the consumer cost and the commonality of parts reducing manufacturing costs.

In a first embodiment of the invention, the brackets are attached to the platform and surround at least the top of the extension arms. The locking screws may be either thumb screws to grip the extension arms or screws which penetrate the extension arms for a more permanent arrangement. The brackets are generally placed at the corners of the platform to provide maximum strength. The platform lies between the extension arms and the backboard rest against the collars.

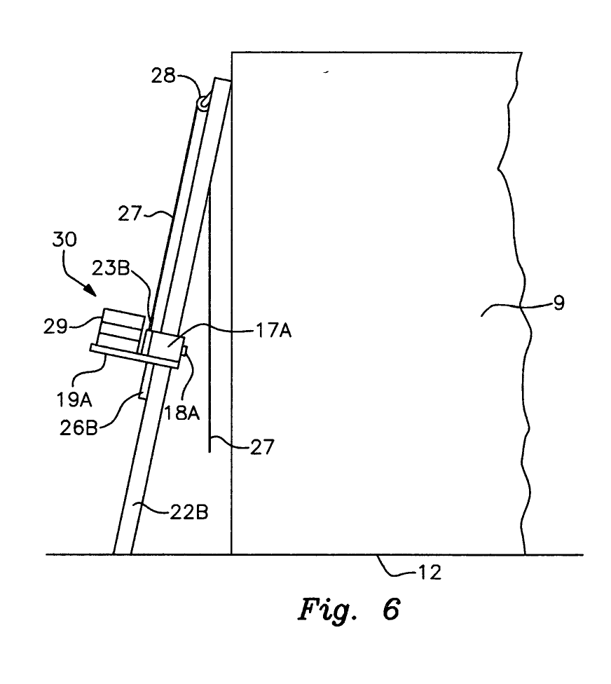

The use of the hoist is shown in FIG. 6. This Figure is a side elevation view of the ladder of the present invention used with the hoist of FIG. 5A. This Figure shows a wall 9, a ground line 12, a ladder with a rail 22B resting on the ground at its bottom and against the wall 9 at its top, and the hoist shown in FIG. 5A. The components of the hoist that can be seen in this Figure include the extension arm 19A, the collar 17A, and the back stop 23B. Added to the ladder is a pulley 28 over which is placed a line 27. One end of the line is attached to the hoist 30 while the other end is dropped down to where an operator can reach it.

To operate the hoist, a load such as 29 shown in FIG. 6 is placed on the platform of the hoist. The load is lifted to the top of the ladder by merely pulling down on the free end of the line. The platform is hinging to allow it to fold up for compact storage. The collars guide the hoist on the rails as the hoist is lifted up by the line 27. The hoist may be clamped at the top or at an intermediate position by tightening the screws 18A and 18B.

In a second embodiment, the hoist 31 of FIG. 5C is almost identical to that of FIG. 5A except the left and right skids 26A and 26B are substituted for collars 17A and 17B. Only right skid 26B can be seen in FIG. 6. The skids are longer than the collars to that they can ride on the ladder rungs and the sled formed by the skids is narrower than the width of the ladder. Otherwise the operation of the two hoists is identical.

A variation which is within the spirit and scope of the invention is to include wheels on the hoist to facilitate raising the hoist on the ladder. The wheels include a ratchet which brake to prevent the hoist from going down unintentionally. The wheels may include a groove to grip the rails or may be doubled with one wheel on each side of a rail to grip the rails and prevent the hoist from shifting off of the ladder. The hoist ratchet is released after removing the load or when it is desired to bring a load down the ladder. A further improvement is to include a brake on the wheels to facilitate lowering the hoist with a load. Another improvement is to add a motor winch to raise the hoist. A still further improvement is to make the hoist collapsible by notching and hinging the base so that it may be folded up for storage purposes.

Having described my invention, I claim all the objects in the summary section above.

1. A ladder comprising:
(a) a plurality of sections each section having a first and a second rail and a plurality of generally uniform steps placed between and connected at each end of the step to one of the rails, causing the rails to be spaced apart by the width of the steps, said steps being generally orthogonal to said rails and
(b) means for connecting one section of the rail to another section at the ends of the rail to form a ladder having a height that is generally a multiple of the length of each section.

2. (canceled)

3. A ladder as claimed in claim 1 wherein each of said rails has a first and a second end, said first end having a cross-section that is smaller than that of said second end and said second end having a cavity which tightly accept the insertion of a first end from another section of ladder into said cavity to permit one section of said ladder to be connected to another section of said ladder.

4. A ladder as claimed in claim 1 wherein said rails have a first and a second end and are uniform in cross section at their ends, said ladder further comprises a first connector that is formed of a section of material which is less than one-forth the height of the ladder sections and has a first and a second end with a cross section larger than that of said rails, said first connector contains a passage way passing through said first connector from the first end to the second end which tightly accepts the end of one rail from a first ladder section at the first end of the first connector and said passageway accepting one end of the rail from a second section of the ladder at the second end of the first connector to connect said first and second section of the ladder together.

5. A ladder as claimed in claim 1 further comprising a second connector having a first and a second end and wherein the rails of a first and a second section of ladder each contain a cavity at their ends and said second connector has a cross section which tightly fits into the cavities of said rails, said first end of said second connector being inserted into said cavity in one of said rails of said first section of the ladder while said second end of said second connector is inserted into said cavity in one of said rails of the second section of the ladder to connect said first and second section of ladder.

6. A ladder as claimed in claim 1 further including a transverse hole passing through the ends of said rails from side to side, said transverse holes at each end of said ladder section lying on a central axis which is generally orthogonal with respect to the longitudinal axis of each rail and parallel to the steps on the ladder.

7. A ladder as claimed in claim 6 having a upper and lower end with said lower end of said ladder resting on the ground and said ladder further comprising a bottom stabilizer which includes a first and a second block and rod having a first and second end, and said rod being inserted through said transverse holes located at the lower end of said ladder, said first block being connected to the first end of said first rod and said second block being connected to the second end of said first rod to stabilize the ladder from tipping.

8. A ladder as claimed in claim 7 further comprising a first and a second spike, said first spike being connected to said first block and said second spike being connected to said second block, said spikes each having a point and said point of each of said spikes being oriented on said block to face downward and be positioned to become embedded in the ground below said ladder when said ladder is rested on the ground to prevent the tipping and skidding of said ladder with respect to the ground.

9. A ladder as claimed in claim 1 wherein said ladder has a lower and an upper end with the lower end resting on the ground, and the upper end position adjacent a vertical structure, said ladder further comprising a top stabilizer which includes a second rod, said second rod having a first and a second end, a third and a forth block, a first rail collar partially surrounding said first rail, but avoiding the steps and a second rail collar partially surrounding said second rail, but avoiding the steps and first releasable means for securing said first rail collar to said first ladder rail and second releasable means for securing said second rail collar to said second ladder rail, said top stabilizer further including a first extension arm attached to the first collar and extending from the first collar towards said structure and a second extension arm attached to the second collar and extending towards said structure, said first and second extension arms having a near end proximate the rails and a far end away from the rails, said far ends of said extension arms each having a hole, said second rod being passed through said holes in said extension arms, said third block being connected to said first end of said second rod and said forth block being connected to said second end of said second rod to space said ladder away from direct contact with said structure allowing said blocks to make contact with said structure and thereby avoid damage to said structure.

10. A ladder as claimed in claim 6 further comprising a third rod and two wheels, said third rod being passed through said transverse holes at one end of a ladder section and one of said wheels being rotatably attached to each end of said rod to facetalate transporting said ladder section on said wheels.

11. A ladder as claimed in claim 10 wherein said ladder comprises a plurality of ladder section positioned side by side with said section through which said third rod has been pass and said wheels have been attached, said ladder further comprising a top, a front, and a bottom panel connected in a “C” shape about said ladder sections to enable said plurality of ladder section to be transported on said wheels.

12. A ladder as claimed in claim 1 wherein said rails have a first and a second end and are uniform in cross section at their ends, said ladder further comprising a third connector that is formed of a section of material which is less than one-forth the height of the ladder sections and has a first and a second end with a cross section larger than that of the rails, said third connector containing a first passage way having central axis which passes through said third connector from the first end to the second end and tightly accept the end of one rail from a first ladder section at the first end of the third connector and also tightly accepts one end of the rail from a second section of the ladder at the second end of the third connector to connect said first and second sections of ladder together, said third connector having a projection on one side, said projection having a second passage way passing through the projection with a central axis that is orthogonal to the central axis of said first passage way, said second passage way having an opening to the outside of said third connector and said second passage way being positioned with its axis orthogonal to said rails, the opening of said second passage way facing outwardly of said ladder, said ladder being positioned with the rails running horizontally to form a section of fence which rests on the projection of said third connector.

13. A ladder as claimed in claim 12 further comprising a third and a forth section of ladder and a second and a third of said third connectors, connecting said third and forth sections of fence together and a forth connector having a length of less than one forth the height of one of said ladder sections and a cross section which fits tightly in said second passage way being inserted into the second passage way of the third connector to connect said first and second sections of ladder and the second passage way of the third connector connecting the third and forth sections of ladder to permit stacking the sections of ladder and supporting them in a stabile position to provide a fence of double the height of that in claim 6 and to provide a support for scaffolding.

14. A ladder as claimed in claim 1 wherein said ladder has a lower and an upper end with the lower end resting on the ground, and the upper end position adjacent a vertical structure, said ladder further comprising a hoist which includes, a first rail collar partially surrounding said first rail, but clearing said steps and a second rail collar partially surrounding said second rail but clearing said step and enabling said hoist to slide up and down on said first and second collars, said hoist further including a cross tray connecting said third and forth collars, said hoist further including a pulley and a line, said pulley being connected to the top of the ladder and said line passing through said pulley and being connected to said hoist to enable said hoist to be raised and lowered on said ladder by drawing on and releasing the free end of said line.

15. A ladder as claimed in claim 1 comprising at least a first and a second of said ladder sections held generally upright with the bottoms spaced apart and the sections connected together at their tops to form a step ladder.

16. A ladder as claimed in claim 15 further comprising a bolt, a nut, a top panel and a bottom panel, said top panel resting on top of the ladder and lying in the horizontal plane, said bottom panel lying below the first step from the top on both ladder sections, said bolt passing through said first and second panels and being secured in place by threading said nut on said bolt and tightly said nut to draw said upper and lower panels together.

17. A ladder as claimed in claim 16 further comprising a first and a second projection on said lower panel, with each projection being located on opposite side of said lower panel and extending upward to capture said first step on each ladder section to prevent said ladder from opening beyond a specific limit.

18. A ladder as claimed in claim 17 further comprising a flexible line connected between said first and second ladder sections below the first step from the top to prevent said sections from spreading beyond a prescribed limit.
